(19) United States
(12) Patent Application Publication
(10) Pub. No.: US 2011/0229113 A1
(43) Pub. Date: Sep. 22, 2011

(54) HEATING DEVICE FOR A THERMOPLASTIC PROSTHESIS SHAFT BLANK

(75) Inventors: Christof KURTH, HEINERSREUTH (DE); Dirk KREMSER, HAMBURG (DE)

(73) Assignee: MEDI GMBH & CO. KG, Bayreuth (DE)

(21) Appl. No.: 13/050,527

(22) Filed: Mar. 17, 2011

(30) Foreign Application Priority Data
Mar. 17, 2010 (DE) 102010011799.4-16

(51) Int. Cl. F27D 11/12

(52) U.S. Cl. 392/418

(57) ABSTRACT

Heating arrangement for a thermoplastic prosthesis socket blank, said heating arrangement comprising a holder (1) for the thermoplastic prosthesis socket blank, and a heating device, wherein the holder has a plate (4), which receives the prosthesis socket blank (2), and one or more radiant heaters (3) for heating the thermoplastic prosthesis socket blank (2).

The invention relates to a heating arrangement for a thermoplastic prosthesis socket blank, said heating arrangement comprising a frame, a holder connected thereto for the prosthesis socket blank, and a heating device.

To produce a prosthesis socket, it is generally necessary to produce an amputation stump model, called a positive model. For this purpose, an impression of the stump is taken in the desired shape and position, e.g. using plaster of Paris. Then, with the aid of this impression, that is to say the negative mold, a positive model is again created. This is done, for example, by filling with plaster or rigid foam. The resulting amputation stump model is then further processed in a suitable way. Another possibility is to scan the amputation stump or to take various separate measurements and transfer these data into suitable image-processing or design software. In this way, a digital model is created that can be further processed by computer. Then, on the basis of the further processed CAD data, the amputation stump model is created by machine, for example with the aid of a milling cutter.

The prosthesis socket is prepared enveloping the positive model thus produced. A distinction is made between final socket and test socket. The test socket is generally prepared from a thermoplastic, is in most cases transparent and can be subsequently modified thermoplastically. However, stability is limited; impact stress can result in spontaneous formation of sharp-edged fractures in the socket. Therefore, after a test socket has been provided and its fit has been optimized, a final socket is produced. This final socket has greater stability, a longer useful life and more resistance to fracture. It is in most cases produced from fiber-reinforced laminate. Final sockets produced in this way are not transparent and cannot be re-worked.

A transparent test socket is generally produced by thermoforming of a plastic sheet that has a thickness of up to 15 mm. This plastic sheet is clamped in a thermoforming frame and is first heated in a forced-air oven until it deforms plastically and sags in the thermoforming frame, the heating taking place until the sheet sags by ca. 20-30 cm. The frame and sheet are then taken from the oven, turned through 180° and pulled over the positive model. Initially, the heated plastic material is pulled mechanically over the positive length of the stump model, after which a vacuum is applied between the positive model and the thermoplastic to permit forming onto the model, as a result of which the softened material is pulled onto the re-worked amputation stump model. The vacuum is undefined and can vary considerably from case to case. Wet and dry positive models of plaster are used as thermoforming model, and also foam bodies. Talc is often used as release agent. This procedure for creating a thermoplastic socket is often unsuccessful, since the removal of the sheet from the oven has to take place at exactly the right time. Otherwise, the sheet sags to such a great extent that the material becomes too thin and therefore no longer has the melt stability necessary for the processing or comes into contact with the floor of the oven.

Another disadvantage of this procedure is that the material is amorphous, and the strong stretching in the longitudinal direction instigates a longitudinal alignment of the molecular chains. Stretch ratios of up to 1:8 arise. The strong stretching and the usually locally different cooling rates (e.g. thin layer on wet plaster/thicker layer on less wet plaster) result, particularly in the case of amorphous materials, in frozen-in strains. The greater the frozen-in strains, the easier the socket can fracture under stress, i.e. the material can become very sensitive to impact as a result of this thermoforming method. If a fracture occurs in the material, this fracture propagates very quickly and extensively in the stretching direction. On account of the glass-like, amorphous structure, this can cause extremely sharp-edged fractures, which can lead to considerable injuries. Moreover, the manual thermoforming method often results in different wall thicknesses, e.g. as a result of locally different thermoforming speeds. These different wall thicknesses likewise contribute to said problem of high impact sensitivity.

It is known from WO 2008/092617 A1 to produce a socket using an innately conically pre-formed plastic structural part. For this purpose, according to the underlying inventive concept of WO 2008/092617 A1, an impression of the stump is taken using a multi-part socket mold which is placed on the amputation stump and whose individual planar parts are movable relative to one another and can be fixed again in the desired optimal position relative to one another. The plastic blank is then inserted into the resulting negative mold and heated using hot air that is blown into the interior of the blank. After sufficient heating, the thermoplastic prosthesis socket blank is inflated by incoming compressed air and is brought to bear against the wall of the previously formed negative mold. A disadvantage of this is that, by blowing in hot air, only a slow heating of the prosthesis socket blank can be achieved. Moreover, it is not possible to achieve uniform and homogeneous heating-through, but only a heating that starts from the inner face of the blank. If, on the inner face of the blank, there is a location whose temperature is appreciably above the average, the compressed air will deform the thermoplastic material more strongly there, since the melt stability decreases with increasing temperature. In this way, the material thins to an above average extent at this location and as a result heats more strongly, which in turn leads to increased bulging, such that the blank can eventually burst at this location.

The problem addressed by the invention is therefore that of making available a heating arrangement that permits a defined, rapid and homogeneous heating or heating-through of the prosthesis socket blank.

This problem is solved by a heating arrangement comprising a holder, preferably arranged on a frame, for the prosthesis socket blank, and a heating device in the form of at least one radiant heater for heating the prosthesis socket blank, wherein the holder has a plate for receiving the prosthesis socket blank. Depending on the embodiment of the invention, this plate can also be mounted so as to be rotatable, such that, during the heating process, the prosthesis socket blank can be moved relative to the radiant heater via a motor.

The heating arrangement according to the invention entails the use of at least one radiant heater for heating the prosthesis socket blank. The radiation spectrum of the radiant heater is to be chosen such that it is absorbed well enough by the thermoplastic material of the prosthesis socket blank, so as to ensure short heating times. However, the radiation must be able to penetrate the thermoplastic well enough to ensure that an approximately homogeneous heating-through of the prosthesis socket blank is maintained through the entire wall thickness.

An infrared radiator is preferably used as radiant heater. The plastic material used is particularly preferably a copolyester, for example based on terephthalic acid, such as PET (polyethylene terephthalate). Compared to the heating arrangements known in the prior art (forced-air oven, hot air), no pre-heating time is needed in the treatment apparatus according to the invention, and in particular there is a very short heating time of usually at most 5 minutes, something that cannot be achieved with the known heating methods.

Moreover, two methods are provided according to the invention in order to ensure, during heating of the socket blank, that the areas of the blank that are to be adapted to the shape of the stump are brought to the desired processing temperature, without partial areas being heated too much or too little.

In the first method, the prosthesis socket blank is arranged on a rotatably mounted plate, wherein this plate is part of a holder via which the blank can be rotatably mounted in or on the frame of the arrangement. This rotation bearing is advantageous in that the prosthesis socket blank can be rotated via a motor. That is to say, the prosthesis socket blank rotates relative to the positionally fixed radiant heater, in other words is moved past the latter. If the radiant heater is bar-shaped, it is possible to achieve very homogeneous heating along the entire length of the blank by suitably adjusting the distance between radiator and blank. For this purpose, for different sizes of blanks, other fixing points respectively can be provided for receiving the radiators on the apparatus. In this way, on the blank completely heated through, the same softness can be achieved at all locations, as a result of which the blank can be formed-on optimally. In this embodiment of the invention, the radiant heater itself can be arranged outside or inside the prosthesis socket blank, and the particularly preferred arrangement outside the prosthesis socket blank permits a simpler structure of the heating arrangement. Moreover, bar-shaped radiators can be used which have a constant radiant power along their length, which makes it possible to use inexpensive, standardized radiators. In principle, as regards the homogeneity and speed of the heating-through of the thermoplastic material, it makes no difference whether the one or more radiant heaters are arranged outside or inside the blank.

In the second method, the one or more radiant heaters are arranged on or about the axis of symmetry of the blank, and the radiant power of the one or more radiators is varied along the axis in accordance with the circumference of the blank. In this embodiment of the invention, the heating arrangement can be kept simple and inexpensive thanks to the omission of rotatably mounted elements. In addition to bar-shaped radiators, it is possible, in an alternative of this embodiment, to use approximately punctiform radiators. A uniform radiation intensity on the inner face of the parts of the blank to be heated can be achieved here by means of the distance between the approximately punctiform radiators being reduced if an increase in the radiant power along the axis of symmetry is desired and/or by controlling the radiant power of the individual radiators. The radiant power acting on a surface increment of the blank is obtained by addition of the powers exerted on this surface by the individual radiators.

On the plate receiving the prosthesis socket blank, there is a connector piece for a compressed-air line for inflating the heated prosthesis socket blank or for inflating a balloon-like inflation element, which is arranged on the plate and which lines the inside of the prosthesis socket blank. That is to say, the plate which holds the prosthesis socket blank, and by which the rotation bearing on the frame is possible, additionally permits the inflation of the blank. It therefore remains on the blank after the heating, even when the blank is inflated and adapted to the shape of the stump. In this way, after sufficient heating, the prosthesis socket blank is removed with the plate from the heating arrangement and, for example, placed in the negative mold of the amputation stump. The blank is inflated by compressed air being blown in, such that it bears optimally against the mold. Between the plate and the prosthesis socket blank, a suitable sealing means can be inserted in order to permit a tight connection between the plate and the edge of the blank. Alternatively, a balloon-like inflation element can be provided, which is arranged on the plate and, for example, directly provides the seal with respect to the prosthesis socket blank. When the inflation element is inflated, it expands and bears against the inside wall of the blank. Upon further inflation, the blank is in this way also necessarily expanded, such that it bears flat from the inside against the negative mold. If, with a radiator lying on the inside, an inflation element is fitted, it is advantageous to design the inflation element such that the heating radiation is able to pass through it in the best possible manner.

As has already been described, in the design with a rotatably mounted plate, the embodiment with one or more radiant heaters arranged outside the blank is particularly preferred. In this embodiment, a preferably telescopic rod is provided, which is fastened centrally to the plate and which passes axially through the prosthesis socket blank and emerges again at the closed end of the prosthesis socket blank through a hole located at this position. The blank is thus received on the frame so as to rotate about its axis of symmetry. This location serves as a second bearing point of the rotation bearing of the blank. The rod is therefore also part of the holder. The blank is thus mounted rotatably at one end via the plate, or a bearing element provided on the plate, and at the other end via the rod. The rod can also pass through the above-described, balloon-like inflation element, which thus surrounds the rod. The rod is also preferably telescopic in this embodiment, as a result of which it is possible, by lengthening the rod, to push the prosthesis socket blank into the outer mold for adaptation thereto.

An alternative to the described blow molding process, in which the heated blank is blown into a hollow stump mold, is the forming of the heated prosthesis socket blank onto a positive mold of the stump. To permit this, an alternative design of the heating arrangement is provided. In this design, the radiant heater is likewise arranged outside the prosthesis socket blank, but on the plate there is a support dome which substantially corresponds to the inner shape of the prosthesis socket blank, such that the prosthesis socket blank can be mounted thereon. The support dome is preferably air-permeable and rotationally symmetrical, and its axis of rotation corresponds to that of the rotary plate. In this embodiment of the invention, therefore, a support dome is first placed on the rotatably mounted plate, onto which support dome the prosthesis socket blank is fitted in turn and, sealed by suitable connecting means, is likewise coupled to the plate. In this way, the prosthesis socket blank is protected against sinking or deforming during the heating process, since it bears across its whole surface on the support dome. After being heated through, it can, like a heated-through thermoforming sheet, be further processed to produce a prosthesis socket, e.g. pulled over a positive plaster model.

This support dome can also advantageously be designed such that its surface reflects the heat radiation, as a result of which the proportion of the radiation that is utilized to heat the blank is increased. This principle of increased efficiency allowed by the invention can also be transferred to designs with radiant heaters arranged inside the blank. For this purpose, a reflector is to be designed around the blank such that the blank, with the closed end facing downward, bears with its areas to be heated fully on the reflector, as a result of which it is possible, after the blank has been heated, to counteract a deformation caused by its inherent weight.

In another alternative design with one or more radiant heaters lying on the outside, a positive model of the stump is secured on the rotary plate, and the blank is secured over this positive model, sealed off with respect to the rotary plate. After sufficient heating, the prosthesis socket blank is sucked onto the positive model by a vacuum being applied between blank and positive model. For this purpose, the positive model is optionally covered with a thin, air-permeable layer, for example a thin stocking.

In the two last-mentioned designs, the rod passing through the positive model and through the blank can be omitted, which requires a rotatable bearing of this arrangement solely via the plate, or a second bearing point is again provided by a pin that passes through the closed end of the prosthesis socket blank and engages in a corresponding seat on the frame.

As regards the rotation bearing of the prosthesis socket blank, different configurations are conceivable. The plate or the rod can be coupled to the motor at the plate end, i.e. the motor transfers its drive power to the holder, in other words to the plate there or to the rod passing through the prosthesis socket blank. However, it is also conceivable that the closed end of the prosthesis socket blank is fixed in a rotatably mounted seat, which is coupled to the motor, while the plate rotates freely.

In a development of the invention, the frame can have a vertically adjustable section by means of which different distances can be set between the plate and the seat for the closed end of the prosthesis socket blank. This allows the frame to be adapted to the size of the prosthesis socket blank, since the production of prosthesis sockets of different sizes, which of course have to meet the given anatomical circumstances, may require different sizes of socket blanks.

Although it is sufficient in principle, in the design with a radiator on the outside, to use only one radiant heater, an expedient development provides for the use of two or more radiant heaters distributed about the circumference of the prosthesis socket blank.

Particularly in the case where the one or more radiant heaters are arranged on the outside, one or more screens can expediently be provided, which may also be designed to reflect the emitted radiation. This has the advantage that there is less unnecessary heating of the area surrounding the arrangement and of the arrangement itself. A design of the screens such that they are reflective is expedient since, if they are suitably configured, the heat radiation emitted in the direction of the screen can in this way be reflected toward the blank, so as also to utilize this part of the radiation for the heating. By suitable design of the screen plates, the radiation can also be concentrated, which narrows the radiating angle such that the heat radiation can be applied in a targeted manner to the blank. The screening can also be integrated in the radiator itself, for example in the form of a non-circumferential metal coating. In this case, protection against burning as a result of inadvertent contact with the radiator also has to be integrated in the apparatus.

In another particularly expedient embodiment of the invention, a control device is used which is assigned a temperature sensor for detecting the temperature of the prosthesis socket blank, wherein the control device controls the operation of the one or more radiant heaters as a function of the detection result from the sensor. This affords the possibility of operating the arrangement depending on the temperature of the prosthesis socket blank. An infrared thermometer can be used, for example, as the sensor. Thus, the radiant heater can be in operation, for example, until a defined limit temperature is reached, whereupon the radiant heater is switched off. An upper and a lower temperature threshold value can also be stored in the control device, wherein the control device switches off the radiant heater when a temperature corresponding to the upper temperature threshold value is detected and, after cooling, switches it on again when a temperature corresponding to the lower temperature threshold value is detected. That is to say, a temperature window is defined within which the heating process, and thereafter also the forming process, is to take place. When, during heating, a temperature of the blank is detected that corresponds to the upper temperature threshold value, the blank is processible, in other words can be deformed. A signal is then optionally output, and the radiant heater is switched off either immediately or with a delay. However, it can, for example, continue to rotate. If the blank is not removed immediately and further processed, the surface temperature of the blank falls again. When the lower temperature threshold value is reached, the radiant heater is switched back on in order to maintain the blank within the temperature window. This heat upkeep or hysteresis mode can optionally be limited in time, for example in order to avoid thermal damage to the thermoplastic. Then, for example, another signal is output which indicates that the heating arrangement is now completely switched off and no further temperature control or heating of the blank takes place. It is also conceivable to control the temperature by regulating the power of the radiator or radiators.

A particularly preferable embodiment is the one in which approximately punctiform radiators arranged about the axis of symmetry in the interior of the blank have to be operated with power control since, with the above-described temperature control present, the power control of these radiators does not require additional software and therefore does not entail additional production costs.

Further advantages, features and details of the invention will become clear from the illustrative embodiments described below and by reference to the drawings, in which:

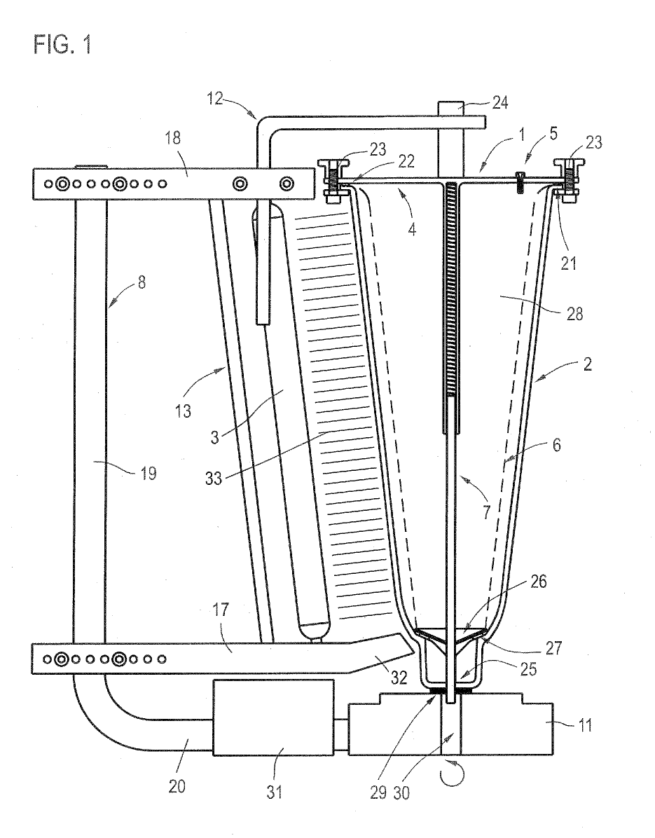

FIG. 1 shows a schematic view of a heating arrangement according to the invention in a first embodiment,

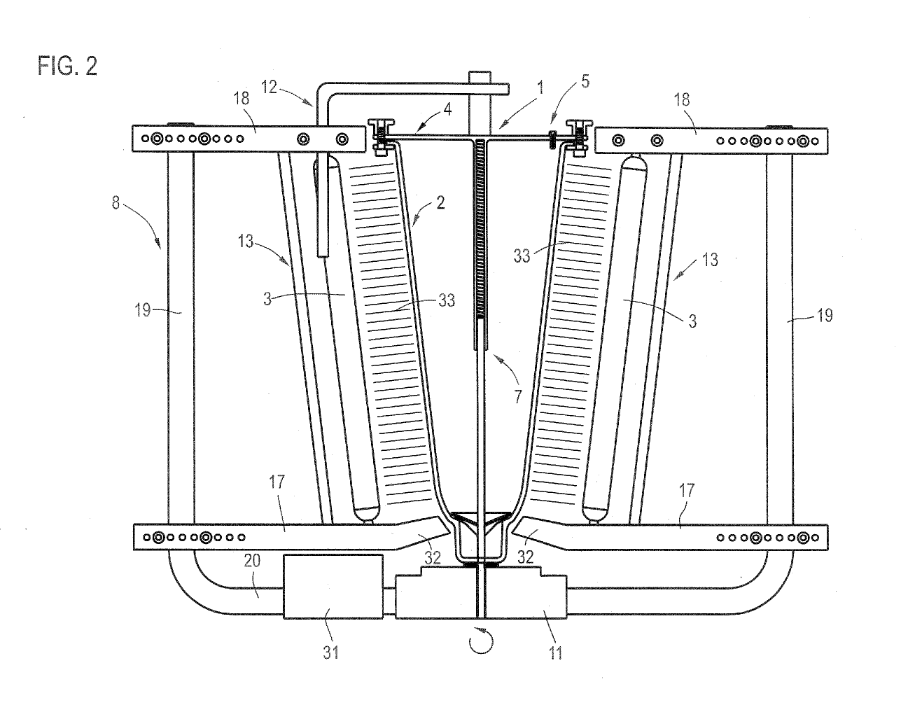

FIG. 2 shows a schematic view of a heating arrangement according to the invention in a second embodiment,

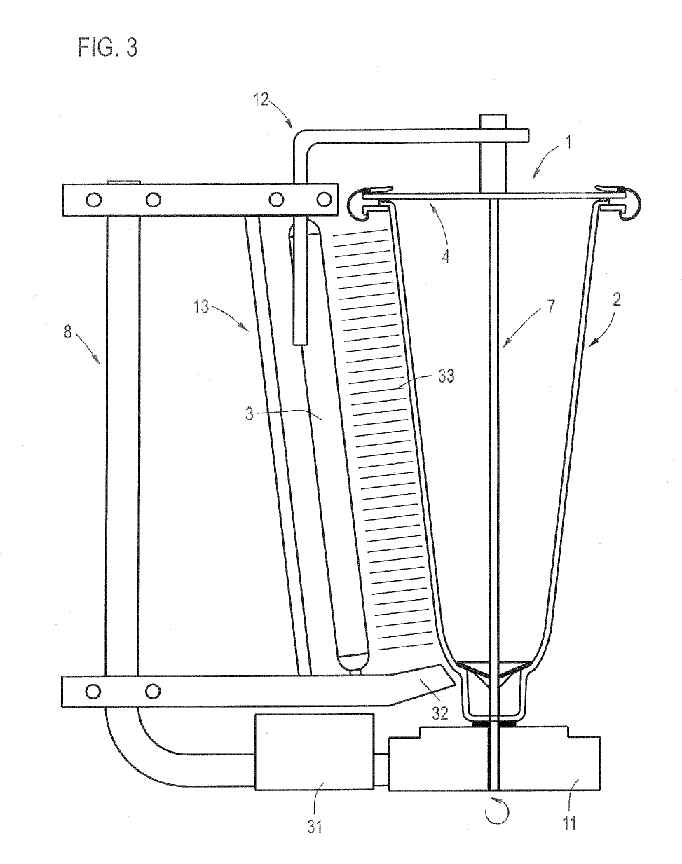

FIG. 3 shows a schematic view of a heating arrangement according to the invention in a third embodiment,

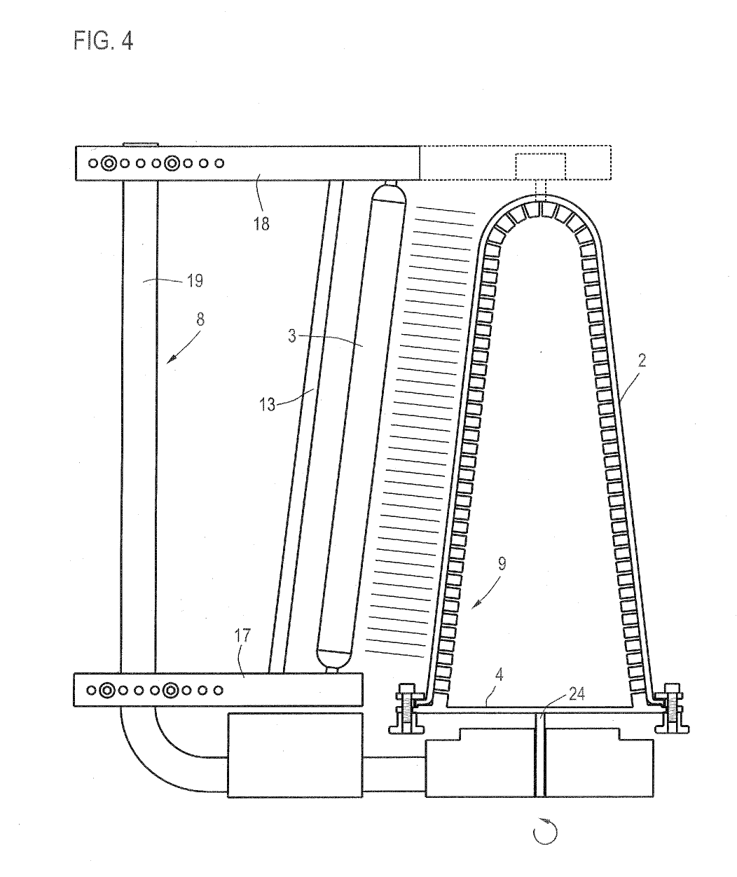

FIG. 4 shows a schematic view of a heating arrangement according to the invention in a fourth embodiment,

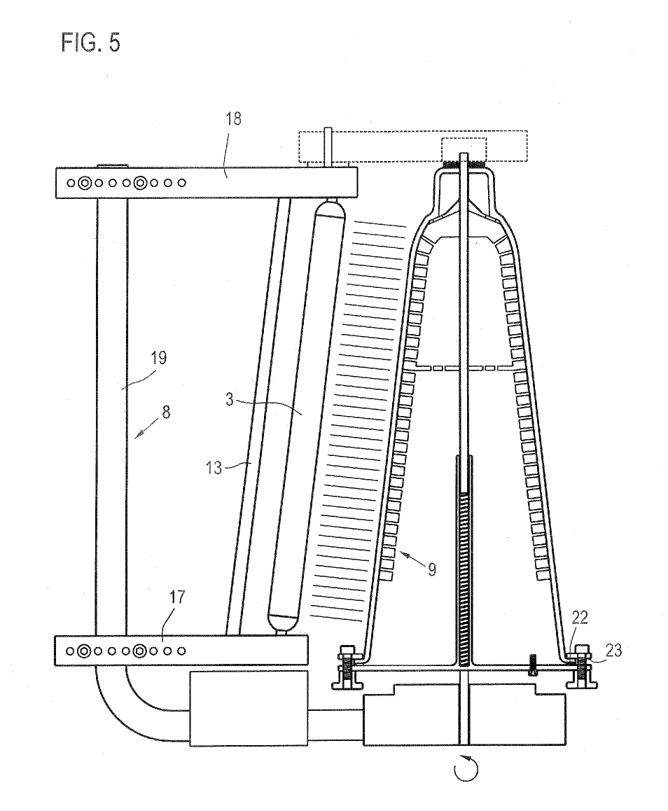

FIG. 5 shows a schematic view of a heating arrangement according to the invention in a fifth embodiment,

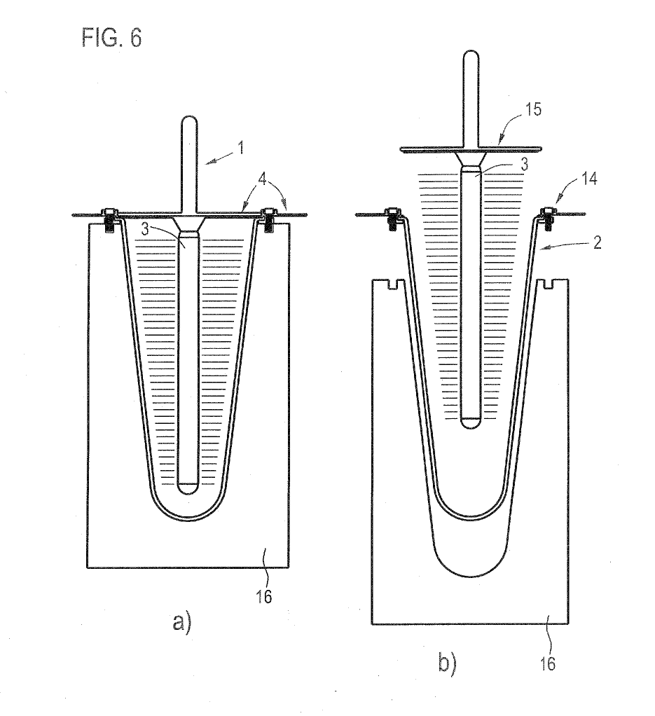

FIG. 6 shows a schematic view of a heating arrangement according to the invention in a sixth embodiment, with the subsidiary views in FIG. 6a and FIG. 6b ,

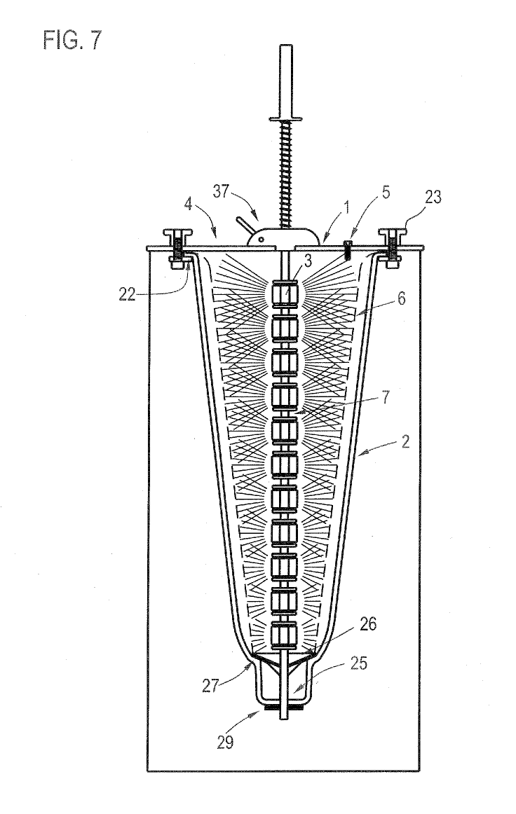

FIG. 7 shows a schematic view of a heating arrangement according to the invention in a seventh embodiment,

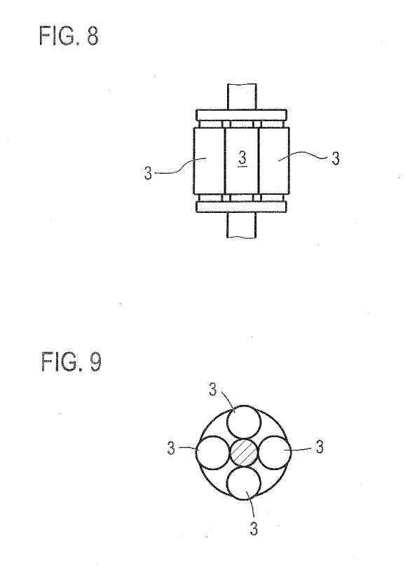

FIG. 8 shows a side view of a radiator unit comprising a plurality of individual radiant heaters, and

FIG. 9 shows a plan view of the radiator unit from FIG. 8.

FIG. 1 shows a heating arrangement according to the invention, comprising a frame 8, on which a heating device in the form of a radiant heater 3 is provided. The radiant heater is arranged on a lower carrier 17 and an upper carrier 18, wherein at least the upper carrier is arranged, and preferably also the lower carrier is arranged, so as to be movable horizontally and/or to be pivotable on a vertical carrier 19 of the frame 8. This makes it possible to change the position and spatial orientation of the radiant heater 3 with respect to the axis of rotation of the prosthesis socket blank 2, in order to adapt the apparatus to different sizes of blanks.

The radiant heater 3, preferably an infrared radiator, is assigned a screen 13, which screens the emitted radiation off from the environment and/or reflects the emitted radiation back to the radiant heater 3 and to the prosthesis socket blank.

A lower horizontal carrier 20 is also provided as part of the frame 8, on which carrier 20 a motor 11 is arranged in order to drive in rotation a plastic prosthesis socket blank 2 to be described below. On the upper support 18, a retainer 12 is arranged, which is pivotable or horizontally movable and vertically adjustable. It serves as a seat or rotation bearing for a holder, to be described below, with which the aforementioned prosthesis socket blank is mounted rotatably. As has been described, the prosthesis socket blank 2, which is made, for example, of transparent plastic, for example an amorphous, aromatic copolyester, is to be heated via the radiant heater 3.

To be able to receive the prosthesis socket blank 2 and position it on the frame, a holder is provided comprising a plate 4, on which the prosthesis socket blank is mounted by its flange-like edge 21. A sealing ring 22 is arranged between plate 4 and edge 21. By suitable fastening means 23, e.g. screws or clips, the prosthesis socket blank 2 is bound in a pressure-tight manner to the plate 4. A bearing journal 24 is provided on the plate 4 and extends through a corresponding opening on the retainer 12 for a rotary bearing. The upper rotation bearing of the prosthesis socket blank 2 is obtained in this way. A connector piece 5 is also shown, to which a compressed-air hose can be connected which is used to inflate the heated prosthesis socket blank 2 after the latter has been removed from the heating arrangement and placed in a mold to be filled by it.

A telescopic rod 7 is also provided, which is arranged on the plate 4 and which is guided through an opening 25 at the lower end of the prosthesis socket blank 2. The telescopic rod 7 is connected to a substantially shallow conical disk 26, which presses a sealing element 27 against the here funnel-shaped inner face of the prosthesis socket blank 2, such that a circumferential radial seal of the interior 28 of the blank is provided in this area. A nut 29, which is screwed onto an outer thread present in this area on the rod 7, ensures that the prosthesis socket blank is pressed sufficiently against the sealing element 27 in order to ensure leaktightness. Moreover, the telescopic rod 7 engages with a form fit in an output shaft 30 (shown only schematically here) of the motor 11, this providing the coupling of the drive mechanism. For this purpose, the rod preferably has a square shape in the lower area. That is to say, the whole prosthesis socket blank 2 can be rotated in this way during operation of the motor 11.

The heating arrangement is controlled via a control device 31, which is only shown schematically here. When a prosthesis socket blank 2 that has been fixed beforehand to the holder 1 comprising plate 4 and rod 7 etc. is to be heated, it is first of all received on the frame. The radiant heater 3 is then positioned by suitable adjustment of the carriers 17, 18, which is sometimes necessary in view of the fact that prosthesis socket blanks 2 of different sizes can be used. The control device 31 then controls the motor 11 and the radiant heater 3. The prosthesis socket blank 2 thus rotates past the radiant heater 3, which emits radiation 32, for example infrared radiation, to the prosthesis socket blank 2. The radiation spectrum is chosen such that it interacts optimally with the plastic material of the prosthesis socket blank 2, in other words such that it penetrates sufficiently into the plastic material and is also well absorbed, thus ensuring that the entire thickness of the material is heated right through homogeneously, as uniformly as possible and with the greatest possible efficiency. The radiation intensity can also optionally be adjusted via the control device 31. The screen 13, along with the screen extension 32 on the lower horizontal carrier 17, ensures that the emitted heat radiation 32 primarily impacts the areas of the prosthesis socket blank 2 that are to be heated.

Two temperature threshold values are preferably stored in the control device 31, namely an upper value and a lower value. By means of a suitable temperature sensor, for example an infrared sensor, it is now possible to measure the surface temperature of the prosthesis socket blank 2. The control now proceeds in such a way that, when a surface temperature is detected that corresponds to the upper threshold value, the control device 31, which communicates with the temperature sensor, switches off the operation of the radiant heater 3, while the motor 11 continues to rotate as before. This necessarily results in slow cooling. When the lower temperature threshold value is reached, the control device 31 starts the radiant heater 3 back up again, i.e. the prosthesis socket blank 2 is heated again. A temperature window is thus defined within which the temperature of the blank changes. This hysteresis can be run through several times. If, after the target temperature is reached for the first time, the prosthesis socket blank 2 is not removed, in order to be further processed, a time interval can pass during which the blank is maintained at a temperature permitting processing. After this time interval has elapsed, a final switch-off takes place, in order to avoid thermal damage to the thermoplastic material. Each time the upper temperature value is reached, the user is informed, for example via a suitable signal (acoustic or visual), that the prosthesis socket blank 2 is able to be processed. Another signal is output when the heating operation is complete. As has already been described, the heated prosthesis socket blank 2 is adapted to the stump shape (not shown here) in an apparatus according to FIG. 1 by means of compressed air being introduced through the connector piece 5 in order to deform the blank 2. In this embodiment, the compressed air acts directly on the inner surface of the blank. However, the broken lines indicate a balloon-like inflation element 6, which is arranged in the inside of the blank and which is clamped instead of the sealing ring 22 in the upper area between the plate 4 and the edge of the blank 21, thus forming the seal. At the lower end, the inflation element 6 can be secured, for example, to the sealing element 27. If air is now blown in, the inflation element 6 deforms and bears on the inside wall of the blank 2, and, upon further inflation, the blank is also expanded. Since the invention only includes the inflation element 6 as an option, the latter is shown by broken lines.

FIG. 2 shows an embodiment of the heating arrangement according to the invention in which two radiant heaters 3 are provided, which are offset by 180° to each other. In other words, the frame 8 has two first carriers 17 and two second carriers 18, and also two vertical carriers 19 and a common lower carrier 20. Each radiant heater 3 is once again assigned at least one screen 13. The control device 31 controls the operation of both radiant heaters 3, which are preferably operated synchronously. By using two radiant heaters 3, simultaneous introduction of energy takes place at two locations, which is advantageous for more uniform and more rapid heating-through. In other respects, this embodiment of the invention is operated in a manner corresponding to the arrangement known from FIG. 1.

FIG. 3 shows another embodiment of a heating arrangement according to the invention, in which the frame 8 corresponds to the frame 8 from FIG. 1. In contrast to the previous embodiments, the prosthesis socket blank 2 is in this case not blow-molded but instead thermoformed. For this purpose, it is not necessary for the blank 2 to be closed in an airtight manner. For this reason, the plate 4 is only designed such that it can be connected by simple quick-clamping elements 34 to the edge of the blank 21. A compressed-air attachment is not necessary here. The rod 7 is not telescopic here, since it does not remain in the blank 2 during the subsequent deforming of the blank (in contrast to the embodiments according to FIGS. 1 and 2). Instead, after the prosthesis socket blank 2 has been sufficiently heated, the plate 4, together with the rod 7 located thereon, is removed from the blank after the quick-clamping elements 34 have been opened. The blank is then transferred to a thermoforming arrangement, where it is adapted to the stump shape by application of a vacuum.

FIG. 4 shows a fourth embodiment of a heating arrangement, which once again has a frame 8 that corresponds, in terms of its function, to the frame from FIG. 1. There are once again a lower carrier 20 and motor 11, a vertical carrier 19, and a lower carrier 17 and upper carrier 18, wherein the two carriers 17 and 18 are mounted pivotably on the vertical carrier 19. A radiant heater 3 and screen 13 are once again provided. In contrast to the previous embodiments, however, the prosthesis socket blank 2 is introduced with the opening facing downward. A plate 4 with a rotary bearing journal 24 is again provided, the rotary bearing journal 24 being coupled directly to the motor output shaft (not shown), thus ensuring the rotational drive of the plate 4. A support dome 9 is arranged on the plate 4. This support dome 9 is either air-permeable or is designed such that it has a multiplicity of air passages [ . . . ]. However, when the heated socket is further processed by thermoforming, the support dome does not need to be air-permeable. The prosthesis socket blank 2 is placed over this support dome 9 and is again connected to the plate 4 by corresponding fastening means 23 using a sealing ring 22. This support dome 9 avoids sinking of the prosthesis socket blank 2 when the latter is heated. It thus has the effect that the blank retains its shape. For this purpose, the support dome has to correspond as exactly as possible to the inner geometry of the blank and should be made from a material which, upon heating, removes the least possible heat from the inner face of the blank. The broken lines indicate a pin 10, which optionally protrudes upward from the support dome 9 and which, if provided, engages in a corresponding rotary bearing seat 36 on the then extended upper carrier 18 (extended area also shown only by broken lines). An upper rotation bearing can be obtained in this way. However, in this embodiment, the lower rotation bearing via the rotary bearing journal 24 is already adequate. During operation, the prosthesis socket blank 2 is heated by the radiant heater 3. After the desired processing temperature has been reached, the plate 4 together with support dome 9 and prosthesis socket blank 2 is removed and placed for further processing, e.g. by thermoforming, in the stump negative mold.

FIG. 5 shows an embodiment which corresponds substantially to FIG. 4 but in which a telescopic rod 7 is provided, which is coupled to the motor 11 and, at the top end, is mounted rotatably. Here too, a support dome 9 is provided in the inside of the prosthesis socket blank and is air-permeable or has air passages. After heating, the blank together with the plate 4 and rod 7 is removed and placed in a stump negative mold. Air is then blown in through the compressed-air connector piece 5 provided here, as a result of which the prosthesis socket blank 2 is inflated through the air-permeable support dome 9.

FIG. 6, comprising subsidiary FIGS. 6a and 6b, shows a fifth embodiment of a heating arrangement, in which the prosthesis socket blank 2 is heated by a bar-shaped radiator 3 which, during the heating process, is located on the axis of symmetry of the blank, such that, viewed circumferentially, the distance between the radiator and the surface of the blank remains constant. Along the longitudinal axis of the radiator, the distance between the surface of the blank and the surface of the blank decreases toward the closed end of the blank. However, in order to ensure uniform heating of the areas of the blank that are to be heated, the radiant power of the radiator decreases toward the closed end of the blank, but in such a way that the same radiant power acts on each surface increment of the areas of the blank that are to be heated. In this embodiment of the invention, the blank 2 is received by an insulating body 16 that ideally reflects the thermal radiation. This insulating body 16 supports the blank 2 across the whole surface thereof, such that the blank does not deform even in the softened state. The upper edge of the blank is screwed onto the plate 4, which in this case is designed in three parts and bears on the insulating body 16, cf. FIG. 6a.

To be able to further process the blank 2 by means of thermoforming, the radiator is removed from the blank (see FIG. 6b) together with the inner plate 15 of the in this case two-part plate 4 consisting of inner plate 15 and outer ring 14, after which the blank 2 can be removed from the insulating support body 16 with the aid of the outer ring 14 of the plate 2. The prosthesis socket blank 2 is secured on the outer ring 14 with the aid of fastening means 23 and of a second ring 35. The further processing takes place analogously to the processing of thermoforming sheets.

FIGS. 7-9 show a sixth embodiment of a heating arrangement according to the invention, which basically corresponds to the embodiment from FIG. 6. Instead of a bar-shaped radiant heater, FIG. 7 has a large number of approximately punctiform radiant heaters 3, which are arranged about the axis of symmetry of the prosthesis socket blank 2 (see FIGS. 8 and 9, which show an individual radiator unit in a side view and in a plan view). Such a radiator unit can be designed as an independent structural part, which can be fitted individually on the rod 7 passing through it. In terms of their radiant power, the individual radiant heaters 3 are chosen and regulated such that their individual radiant fields superpose one another on the surface of the prosthesis socket blank such that the same radiant power acts on each surface increment of the areas of the blank that are to be heated. Tubular lamps, for example, can be used here as radiators.

FIG. 7 shows an embodiment allowing the prosthesis socket blank 2 to be processed in the above-described blow-molding method. For this purpose, the elements 4, 5, 6, 22, 23, 25, 26, 27 and 29 described with reference to FIG. 1 are also part of this embodiment and have the same function as in FIG. 1.

Since it is sometimes necessary in the production of prosthesis sockets to widen the open end in a funnel shape, e.g. in order to create a bearing zone in a thigh socket, it is expedient, when processing the blank by blow molding, to be able to shorten the length of the blank during the blow molding process. In the embodiment shown, this is achieved by the fact that, after unlocking of a clamping device 37 through which the rod 7 is guided sealingly, the rod 7 can be pulled out of the plate 4 assisted by a spring. In the embodiment shown, the path along which the rod 7 can be removed amounts at most to the distance between the plate 4 and the uppermost radiator unit. If, during the processing of the blank with a heating apparatus of this kind, the length is to be able to be shortened still further, it is either possible for the upper radiator units 3 with their contact plates to be secured on the rod so as to be movable downward on the latter, or for each of the radiator units to be mounted on sleeves engaged on the rod 7, which sleeves can be pushed one into another.

A prosthesis socket blank can be heated quickly and easily by means of the heating arrangement according to the invention.

1. Heating arrangement for a thermoplastic prosthesis socket blank, said heating arrangement comprising a holder for the thermoplastic prosthesis socket blank, and a heating device, characterized in that the holder has a plate, which receives the prosthesis socket blank, and one or more radiant heaters for heating the thermoplastic prosthesis socket blank.

2. Heating arrangement according to claim 1, characterized in that the one or more radiant heaters are arranged inside or outside the thermoplastic prosthesis socket blank.

3. Heating arrangement according to claim 1, characterized in that, on the plate, a connector piece is provided for a line for inflating the heated thermoplastic prosthesis socket blank itself or for inflating a balloon-like inflation element, which is arranged on the plate and which passes through the thermoplastic prosthesis socket blank.

4. Heating arrangement according to claim 1, characterized in that, on the plate, a preferably telescopic rod is provided, which passes through the thermoplastic prosthesis socket blank and which emerges at the closed end of the thermoplastic prosthesis socket blank and can be fixed to a frame.

5. Heating arrangement according to claim 1, characterized in that, on the plate, a thermally insulating support body is provided which stabilizes the shape of the thermoplastic prosthesis socket blank, even after softening thereof, and which is preferably air-permeable and is preferably designed to reflect the radiation of the radiant heaters and preferably either has a pin, which passes through the thermoplastic prosthesis socket blank at the closed end of the latter and can be fixed to a frame, or is arranged on a telescopic rod that emerges at the closed end of the thermoplastic prosthesis socket blank and that can be fixed to a frame.

6. Heating arrangement according to claim 1, characterized in that the rotatably mounted plate, the rod that can be fixed rotatably to the frame, or a pin passing through the closed end of the thermoplastic prosthesis socket blank is coupled to a motor, or is fixed in a rotatably mounted seat coupled to a motor, in such a way that the thermoplastic prosthesis socket blank is rotatable via the motor in relation to the one or more radiant heaters.

7. Heating arrangement according to claim 1, characterized in that a frame is provided, which has a vertically adjustable section on which the holder can be mounted.

8. Heating arrangement according to claim 1, characterized in that, for the one or more radiant heaters, one or more screens are provided which, on their side facing the radiator, are preferably designed to reflect the emitted radiation.

9. Heating arrangement according to claim 1, characterized in that one or more radiant heaters are arranged along the axis of symmetry of the prosthesis socket blank or symmetrically around the latter.

10. Heating arrangement according to claim 1, characterized in that the one or more radiant heaters are designed such that their radiant power increases toward the open end of the prosthesis socket blank and in a way which, despite the varying distance between prosthesis socket blank and radiant heater, ensures a uniform heating of all the areas that are to be heated.

11. Heating arrangement according to claim 1, characterized in that the radiant heaters have an approximately punctiform configuration and are arranged in series along the axis of symmetry of the prosthesis socket blank and are chosen, in terms of their radiant power, such that their radiation is superposed on the prosthesis socket blank in such a way that, despite the varying distance between the prosthesis socket blank and the individual radiant heaters, a uniform heating of all the areas that are to be heated is ensured.

12. Heating arrangement according to claim 1, characterized in that the one or more radiant heaters can be positioned in relation to the prosthesis socket blank in such a way that, because of the varying distance between the prosthesis socket blank and the one or more radiant heaters, a uniform heating of all the areas that are to be heated is ensured.

13. Heating arrangement according to claim 1, characterized in that one radiant heater is an infrared heater.

14. Heating arrangement according to claim 1, characterized in that a control device is provided which is assigned a temperature sensor for detecting the temperature of the thermoplastic prosthesis socket blank, wherein the control device controls the operation of the one or more radiant heaters and/or of the motor as a function of the detection result from the sensor.

15. Heating arrangement according to claim 14, characterized in that an upper and a lower temperature threshold value are stored in the control device, wherein the control device switches off the radiant heater and optionally the motor when a temperature corresponding to the upper temperature threshold value is detected and, after cooling, switches them on when a temperature corresponding to the lower temperature threshold value is detected.

16. Heating arrangement according to claim 1, characterized in that the plate is designed in two parts with an outer ring and with an inner plate that is fitted removably in the latter, wherein the outer ring serves as a seat for the thermoplastic prosthesis socket blank, and the inner plate carries the one or more radiant heaters.

17. Heating arrangement according to claim 1, characterized in that, during the heating, the thermoplastic prosthesis socket blank with holder is received with a form fit by a thermally insulating body, which provides support after the softening temperature is reached, wherein the thermally insulating body is preferably designed in such a way that the inner face thereof reflects the heat radiation emitted by the one or more radiant heaters arranged in the interior of the prosthesis socket blank.
